(19) United States
(12) Patent Application Publication
(10) Pub. No.: US 2025/0310447 A1
(43) Pub. Date: Oct. 2, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Kenji SAWAI, Kanagawa (JP)

(73) Assignee: FUJIFILM Business Innovation Corp., Tokyo (JP)

(21) Appl. No.: 18/778,432

(22) Filed: Jul. 19, 2024

(30) Foreign Application Priority Data
Mar. 27, 2024 (JP) 2024-052469

(51) Int. Cl. H04N 1/00

(52) U.S. Cl. CPC H04N 1/00344; H04N 1/00068; H04N 1/00079

(57) ABSTRACT

An information processing system includes a processor configured to provide, to a responder who responds to a user using a device in which a failure has occurred, a sufficiency level of information regarding a solution for the failure based on information provided from the user.

### CROSS-REFERENCE TO RELATED APPLICATIONS

This application is based on and claims priority under 35 USC 119 from Japanese Patent Application No. 2024-052469 filed Mar. 27, 2024.

### BACKGROUND

### (i) Technical Field

The present disclosure relates to an information processing system and a non-transitory computer readable medium.

### (ii) Related Art

For example, Japanese Unexamined Patent Application Publication No. 2008-242577 discloses an inquiry response support system in which a server, upon receiving an inquiry about a product from a user, extracts a keyword of the inquiry or failure from the content of the inquiry, compares the keyword with a keyword database, searches inquiries received in the past for a similar inquiry or failure, transmits the inquiry from the user to a terminal of a responder together with the result of the search, to be used as a reference regarding the level of a response to the inquiry received from the user.

### SUMMARY

Aspects of non-limiting embodiments of the present disclosure relate to an information processing system that makes it easier for a responder who responds to a user using a device in which a failure has occurred to determine the suitability of a response, as compared with a case where only a question to the user and an answer are displayed to the responder.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to provide, to a responder who responds to a user using a device in which a failure has occurred, a sufficiency level of information regarding a solution for the failure based on information provided from the user.

### BRIEF DESCRIPTION OF THE DRAWINGS

Exemplary embodiments of the present disclosure will be described in detail based on the following figures, wherein:

FIG. 1 is a diagram illustrating a processing system according to an exemplary embodiment of the present disclosure;

FIG. 2 is a diagram illustrating a configuration of a computer used by a responder according to the exemplary embodiment of the present disclosure;

FIG. 3 is a diagram illustrating content displayed on a display unit according to the exemplary embodiment of the present disclosure;

FIG. 4 is a diagram illustrating the content displayed on the display unit according to the exemplary embodiment of the present disclosure following FIG. 3, and is a diagram illustrating the content in a state in which information provided from a user is input to an input field;

FIG. 5 is a diagram illustrating the content displayed on the display unit according to the exemplary embodiment of the present disclosure following FIG. 4, and is a diagram illustrating the content in a state in which information is additionally provided by the user;

FIG. 6 is a diagram illustrating the content displayed on the display unit according to the exemplary embodiment of the present disclosure following FIG. 5, and is a diagram illustrating the content display unit in a state in which an information sufficiency level exceeds a target value due to further additional information from the user;

FIG. 7 is a diagram illustrating the content displayed on the display unit according to the exemplary embodiment of the present disclosure following FIG. 6, and is a diagram illustrating the content in a state in which a cause of the failure is determined to be identified due to further additional information from the user;

FIG. 8 is a diagram illustrating a procedure in which a computer according to the exemplary embodiment of the present disclosure provides an information sufficiency level to the responder;

FIG. 9 is a diagram illustrating a first example of a method by which the computer according to the exemplary embodiment of the present disclosure calculates an information sufficiency level, and is a diagram illustrating a table of correspondence between terms and information sufficiency level;

FIG. 10 is a diagram illustrating a state in which the computer according to the exemplary embodiment of the present disclosure calculates an information sufficiency level based on terms input to an input field for failure details;

FIG. 11 is a diagram illustrating a state in which the computer according to the exemplary embodiment of the present disclosure calculates an information sufficiency level based on terms input to the input field for failure details following FIG. 10, and is a diagram illustrating an example in which the information sufficiency level is raised due to further addition of words to the input field for failure details;

FIG. 12 is a diagram illustrating a second example of the method by which the computer according to the exemplary embodiment of the present disclosure calculates an information sufficiency level, and is a diagram illustrating a table of correspondence between terms and information sufficiency level;

FIG. 13 illustrates how the computer according to the exemplary embodiment of the present disclosure calculates an information sufficiency level based on terms input to the input field for failure details, and how a plurality of causes of failures are estimated;

FIG. 14 is a diagram illustrating how the computer according to the exemplary embodiment of the present disclosure calculates information sufficiency levels based on terms input to the input field for failure details following FIG. 13, and is a diagram illustrating a state in which input fields for failure details are provided corresponding to a plurality of respective causes of failures;

FIG. 15 is a diagram illustrating how the computer according to the exemplary embodiment of the present disclosure calculates information sufficiency levels based on terms input to the input fields for failure details following FIG. 14, and is a diagram illustrating an example where the information sufficiency levels are raised with words further added to the input fields for failure details corresponding to the plurality of respective causes of failures;

FIG. 16 is a diagram illustrating content displayed on the display unit according to the exemplary embodiment of the present disclosure, and is a diagram illustrating a state in which the respective information sufficiency levels are displayed for the plurality of causes of failures; and

FIG. 17 is a diagram illustrating a third example of the method by which the computer according to the exemplary embodiment of the present disclosure calculates an information sufficiency level.

### DETAILED DESCRIPTION

Hereinafter, an example of an exemplary embodiment of the present disclosure will be described with reference to the drawings. Note that in the drawings, the same or equivalent components and parts are denoted by the same reference signs. In addition, dimensional ratios in the drawings are exaggerated for convenience of description and may be different from actual ratios.

### Exemplary Embodiment

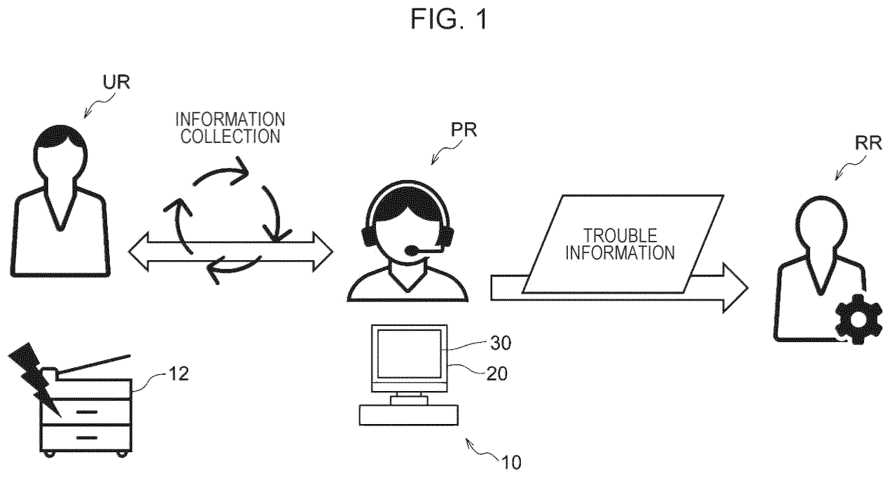

FIG. 1 is a diagram illustrating a usage example of a reception system 10 which is an example of an information processing system according to the present exemplary embodiment. As illustrated in FIG. 1, the reception system 10 is used by a responder PR who responds to a user UR who is a person using a printer 12. In addition, the responder PR provides a repair person RR with information obtained based on information provided from the user UR.

More specifically, as illustrated in FIG. 1, when a certain failure occurs in the printer 12 used by the user UR and the printer 12 becomes unavailable, the user UR inquires of a call center about the failure of the printer 12 over the phone. The responder PR who works for the call center collects the cause of the failure from the user UR by asking a question about the cause of the failure of the printer 12, by using the reception system 10. Then, the responder PR provides the repair person RR, who is an example of the next person in charge, with the details of the solution for the failure obtained based on the information provided from the user UR. Then, the repair person RR visits the user UR and addresses the cause of the failure of the printer 12 based on the details of the solution for the failure provided by the responder PR. Alternatively, the user UR may be contacted by a way of communication such as a phone call, and be informed of a countermeasure based on a more profound knowledge for solving the problem.

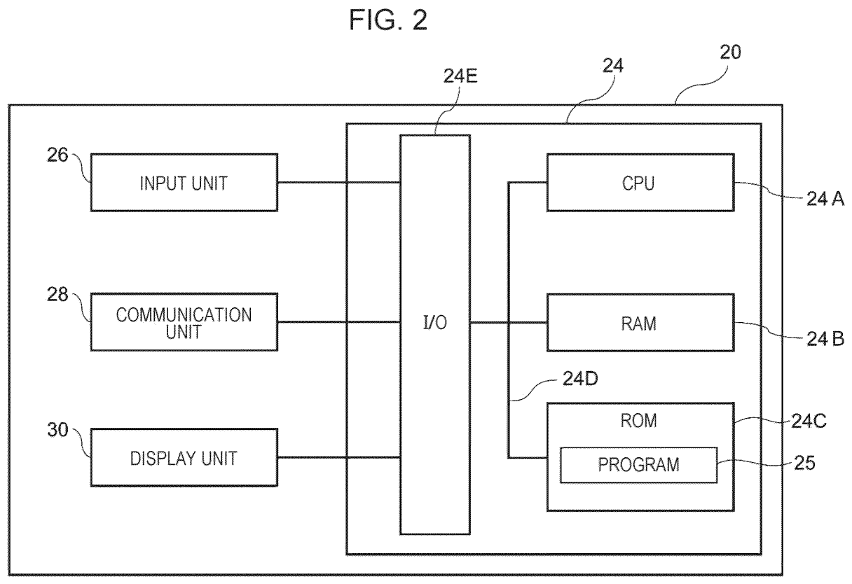

Next, the reception system 10 according to the present exemplary embodiment will be described by referring to FIGS. 2 to 17 as appropriate. The reception system 10 functions when the responder PR executes a program 25 on a computer 20 illustrated in FIG. 2.

### (Computer 20)

As illustrated in FIG. 2, the computer 20 includes a control unit 24, a communication unit 28, an input unit 26, and a display unit 30. Furthermore, as illustrated in FIG. 2, the control unit 24 includes a CPU 24A, a RAM 24B, a ROM 24C, and an input/output interface (I/O) 24E. These components are connected to each other via a control bus 24D.

The CPU 24A is a central processing unit which is an example of a “processor”, which executes various programs and controls the components. The RAM 24B serves as a work area and temporarily stores therein programs or data. The ROM 24C stores various types of data including a “program” according to the present disclosure.

In the control unit 24, the CPU 24A reads various programs including the program 25 from the ROM 24C, and executes the program 25 using the RAM 24B as a work area. By executing the processing program 25, the CPU 24A realizes various functions for controlling the components of the computer 20. However, the processor that executes the program 25 is not limited to the CPU 24A, and a mode may be employed in which a control unit of a computer connected to a network executes the program 25, and the CPU 24A of the control unit 24 acquires the execution result.

The input unit 26 is a device that receives an instruction from the responder PR and notifies the CPU 24A of the control unit 24 of the received instruction. As the input unit 26, for example, an input device such as a touch panel, a pointing device, or a voice input device is used.

The display unit 30 is a device that displays, to the responder PR, a result obtained by the CPU 24A of the control unit 24 executing the program 25. As the display unit 30, for example, a display device such as a touch panel or a display is used.

The communication unit 28 is a component for communicating with other devices via a network (not illustrated). Specifically, the communication unit 28 communicates with other devices by using wired or wireless communications, as well as communications using the Internet, an intranet, and a public line such as a telephone line.

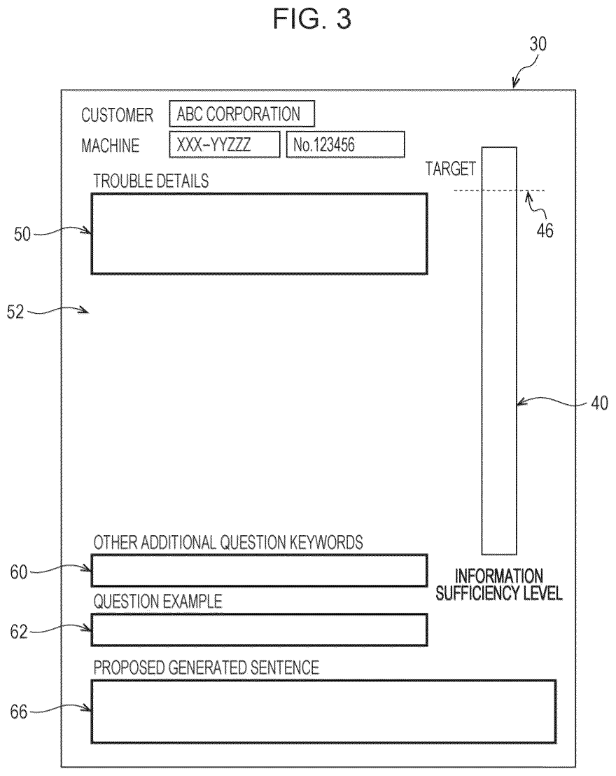

On the display unit 30 of the computer 20, as illustrated in FIG. 3, a failure detail input field 50, an additional question display field 52, an other additional question keywords display field 60, an additional question example sentence display field 62, a proposed generated sentence display field 66, and an information meter 40 as an example of an information sufficiency level are displayed.

The failure detail input field 50 is a field in which the responder PR inputs the details of the failure explained by the user UR in a procedure in which the responder PR receives the details of the failure, which will be described later. In the additional question display field 52, the other additional question keywords display field 60, and the additional question example sentence display field 62, the content of a further question to the user UR is displayed according to the content input to the failure detail input field 50 by the responder PR, in the procedure in which the responder PR receives the details of the failure which will be described later.

The proposed generated sentence display field 66 is a field in which information referred to by the repair person RR is displayed when the responder PR inputs the details of the failure provided from the user UR. In other words, the proposed generated sentence display field 66 is a field for displaying the content related to the solution for the failure provided to the repair person RR from the responder PR. In the proposed generated sentence display field 66, in the procedure in which the responder PR receives the details of the failure which will be described later, the content related to the solution for the failure to be provided to the repair person RR is displayed in accordance with the content input to the failure detail input field 50 by the responder PR. That is, the proposed generated sentence display field 66 is an example of details of the device failure to be provided to the next person in charge in the present exemplary embodiment.

The information meter 40 is, for example, what is known as a progress bar that displays the sufficiency level of information provided from the user UR when the responder PR inputs the details of the failure provided from the user UR. Further, as illustrated in FIG. 3, a target value 46 is displayed on the information meter 40. The target value 46 indicates a level of information that the repair person RR wants to know in advance before visiting the user UR, as the content that the responder PR explains to the repair person RR as illustrated in FIG. 1 in order to solve the failure of the printer 12. Thus, displaying the information meter 40 is an example of providing the information sufficiency level regarding a solution for a failure to the responder PR responding to the user UR, according to the present exemplary embodiment. Note that the target value 46 is appropriately set according to the content of the response to the user UR the repair person RR requires the responder PR of the call center to make, the skill of the repair person RR, and the like.

In the following description, it is assumed that the “information sufficiency level” indicates, as an example, whether the cause of the failure occurring in the printer 12, which is estimated based on the information provided from the user UR, is narrowed down. Specifically, a current value 42 of the information sufficiency level is assumed to be higher when the cause of the failure that has occurred in the printer 12 is more precisely narrowed down, and is assumed to be lower when the cause of the failure that has occurred in the printer 12 is less precisely narrowed down.

Next, when the responder PR according to the present exemplary embodiment is inquired by the user UR about a failure of the printer 12, the responder PR asks the user UR a question while checking the display content of the display unit 30, thereby receiving the details of the failure from the user UR. Next, the procedure in which the responder PR receives the details of the failure will be described.

(Procedure in which Responder PR Receives Details of Failure)

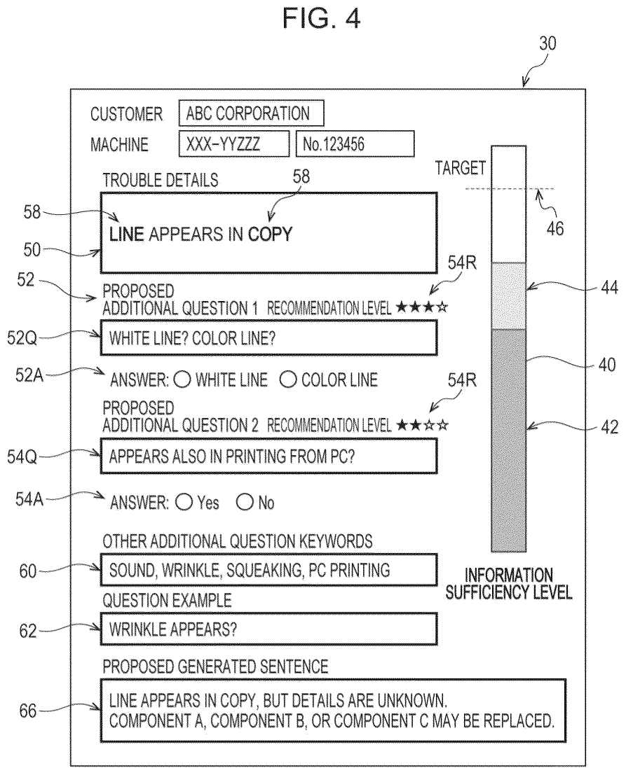

When a failure occurs in the printer 12 used by the user UR, the user UR makes an inquiry to the responder PR over the phone to explain the details of the failure to the responder PR. Next, as illustrated in FIG. 4, the responder PR inputs the details explained by the user UR (that is, what the user UR has said) in the failure detail input field 50.

In the reception system 10 of the present exemplary embodiment, when the responder PR inputs the details explained by the user UR in the failure detail input field 50, the CPU 24A changes the display content of the display unit 30.

More specifically, as illustrated in FIG. 4, the CPU 24A displays, in the additional question display field 52, candidates for content of an additional question made by the responder PR to the user UR, based on the words input to the failure detail input field 50. For example, in FIG. 4, two proposed additional questions 54Q are each displayed in the additional question display field 52 together with an answer field 54A, and the responder PR can determine an additional question to the user UR from the two proposed additional questions 54Q displayed in the additional question display field 52. Thus, displaying the proposed additional questions 54Q is an example of providing, to the responder PR, candidates for a question to the user UR, the question contributing to an increase in the information sufficiency level, according to the present exemplary embodiment.

Note that as illustrated in FIG. 4, each of the two proposed additional questions 54Q displayed in the additional question display field 52 has a rank 54R indicating the “level of recommendation”. As will be described later, the rank 54R is an indication for prompting the responder PR to ask the user UR the proposed additional question 54Q the answer for which largely increases the information sufficiency level.

Furthermore, as illustrated in FIG. 4, based on the words input to the failure detail input field 50, the CPU 24A displays, in the other additional question keywords display field 60, candidates such as words included in the content for which the responder PR makes an additional question to the user UR. For example, in FIG. 4, four words are each displayed in the additional question keyword display field 60, and from the words displayed in the other additional question keywords display field 60, the responder PR can come up with an additional question to ask the user UR. Thus, displaying a candidate such as a word in the additional question keywords display field 60 is another example of providing, to the responder PR, a candidate for a question to the user UR, the question contributing to an increase in the information sufficiency level in the present exemplary embodiment.

Furthermore, as illustrated in FIG. 4, the CPU 24A displays, in the additional question example sentence display field 62, candidates for an example sentence as the content of the additional question from the responder PR to the user UR, based on the words input to the failure detail input field 50. For example, in FIG. 4, an example sentence including a word displayed in the other additional question keywords display field 60 is displayed in the additional question example sentence display field 62, and the responder PR can check the example sentence displayed in the additional question example sentence display field 62 and come up with an additional question to the user UR. Thus, displaying the additional question example in the additional question example sentence display field 62 is another example of providing, to the responder PR, the candidate for the question to the user UR, the question contributing to an increase in the information sufficiency level, according to the present exemplary embodiment.

Additionally, as illustrated in FIG. 4, the CPU 24A displays in the proposed generated sentence display field 66, an example sentence the content of which is reported from the responder PR to the repair person RR, based on the words input to the failure detail input field 50. For example, in FIG. 4, example sentences to be reported for addressing the estimated cause of the failure, based on the words input to the failure detail input field 50 are displayed in the proposed generated sentence display field 66. FIG. 4 illustrates the proposed generated sentence display field 66 indicating a state in which the cause of the failure occurring in the printer 12 is not narrowed down by the words input to the failure detail input field 50, a plurality of causes of the failure are estimated, and the information provided from the user UR is insufficient. Then, as illustrated in FIG. 4, the responder PR can check the example sentence displayed in the additional question example sentence display field 62 and come up with an additional question to the user UR. Displaying the example sentence the content of which is reported to the repair person RR from the responder PR in the additional question example sentence display field 62 is an example of generating the content related to the solution for the failure of the device, to be provided to the next person in charge by the responder PR. In addition, as illustrated in FIG. 4, displaying the example sentence the content of which is reported to the repair person RR from the responder PR together with the proposed additional question 54Q, the additional question keywords display field 60, and the additional question example sentence display field 62 is an example of providing, to the responder PR, the content related to the solution for the failure together with the candidate for the question.

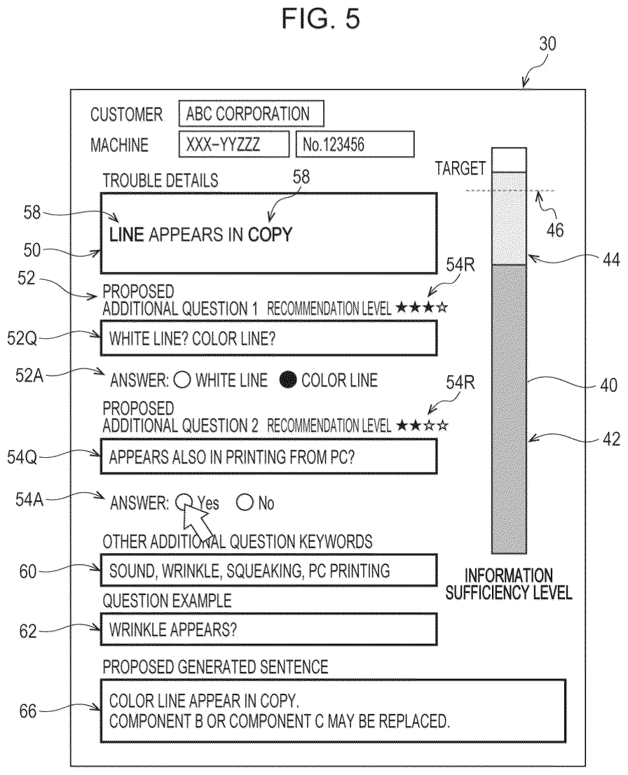

Furthermore, as illustrated in FIG. 4, the CPU 24A changes the display of the information meter 40 based on words input to the failure detail input field 50. For example, FIG. 4 displays the information meter 40 displayed in a case where a plurality of causes of a failure occurring in the printer 12 are estimated based on words input to the failure detail input field 50. Here, since it is estimated that there are a plurality of causes of the failure from the words input to the failure detail input field 50, the information meter 40 indicates that the current value 42 of the information sufficiency level is lower than that in a subsequent state, that is, the current value 42 of the information sufficiency level is low (see also FIGS. 5 to 7).

Further, as illustrated in FIG. 4, the information meter 40 displays, as an expected increase amount 44 of the current value 42 of the information sufficiency level achieved when an answer to the “proposed additional question 1” is obtained from the user UR. In the present exemplary embodiment, the expected increase amount 44 displayed on the information meter 40 indicates the increase in the information sufficiency level that is achieved when an answer is obtained from the user UR for the proposed additional question 54Q of the highest rank among the proposed additional questions 54Q. In other words, the proposed additional questions 54Q are displayed in descending order of the amount of increase in the information sufficiency level. Thus, displaying the proposed additional questions 54Q in descending order of the amount of increase in the information sufficiency level is an example of providing the proposed additional questions in descending order of the amount of increase in the information sufficiency level according to the present exemplary embodiment.

As illustrated in FIG. 4, the CPU 24A highlights and displays a term, among words input to the failure detail input field 50, largely increasing the information sufficiency level. For example, in FIG. 4, in the failure detail input field 50, “copy” and “line” are each displayed while being highlighted, so that the responder PR can come up with a question related to a term largely increasing the information sufficiency level. Thus, displaying “copy” and “line” in an emphasized manner in the failure detail input field 50 of is an example of emphasizing and presenting to the responder PR, information largely increasing the information sufficiency level according to the present exemplary embodiment.

FIG. 5 illustrates an example of a state in which the responder PR has asked the user UR a question about the content of the proposed additional question 54Q displayed in the additional question display field 52 in the state illustrated in FIG. 4, and selected the answer field 54A based on the answer obtained from the user UR. In the reception system 10 according to the present exemplary embodiment, when the responder PR selects the answer field 54A based on the answer obtained from the user UR, the CPU 24A changes the display content of the display unit 30 as illustrated in FIG. 5.

More specifically, as illustrated in FIG. 5, the CPU 24A changes the display of the additional question display field 52, the other additional question keywords display field 60, and the additional question example sentence display field 62 based on the content of the answer in the answer field 54A selected by the responder PR. Furthermore, as illustrated in FIG. 5, the CPU 24A changes the display of the proposed generated sentence display field 66, the information meter 40, and the expected increase amount 44 based on the content of the answer in the answer field 54A selected by the responder PR. Thus, the CPU 24A changes the display of the display unit 30 in the same manner as in FIG. 4 based on the content of the answer in the answer field 54A selected by the responder PR, which is the information newly provided in FIG. 5.

As illustrated in FIG. 5, since information provided from the user UR has increased from the state in FIG. 4, the sentence displayed in the proposed generated sentence display field 66 indicates more specific content of work to be performed by the repair person RR compared with the state illustrated in FIG. 4. Thus, displaying a more specific sentence in the proposed generated sentence display field 66 is an example of changing the content related to the solution for the failure in accordance with the information sufficiency level according to the present exemplary embodiment.

Further, as illustrated in FIG. 5, since the information provided from the user UR is increased as compared with the state in FIG. 4, the current value 42 of the information meter 40 displayed is increased. Here, as illustrated in FIG. 5, the display of the information meter indicates an increase in the information sufficiency level from the state in FIG. 4. In FIG. 5, the expected increase amount 44 of the information meter 40 is displayed as the expected increase amount 44 of the information sufficiency level increased when the user UR answers the “proposed additional question 2”.

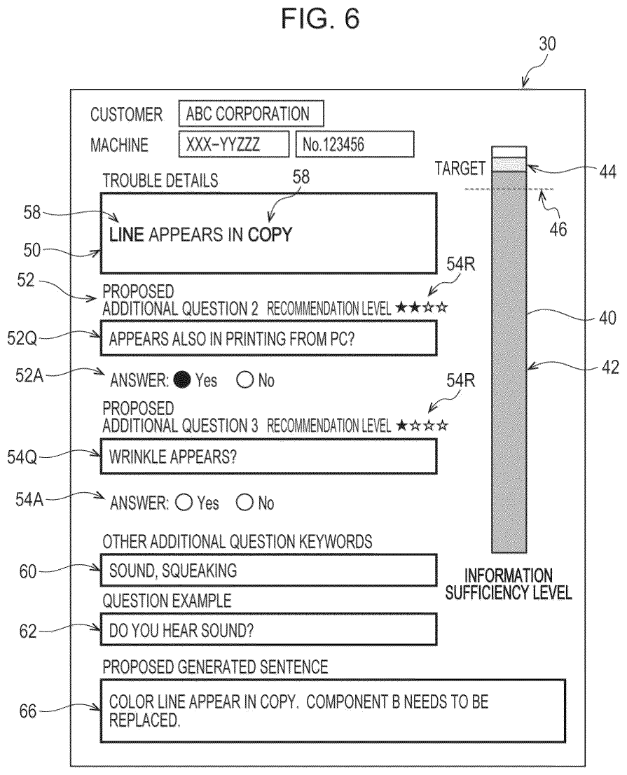

Then, when the responder PR selects the answer field 54A based on the answer obtained from the user UR as in the above-described operation, the content of the display on the display unit 30 is changed as illustrated in FIG. 6.

A larger amount of information on a failure occurring in the printer 12 provided from the user UR leads to a lower risk of the repair person RR encountering an unexpected situation. In other words, the information on the failure provided from the user UR to the repair person RR may be provided such that the sufficiency level of such information exceeds the target value 46.

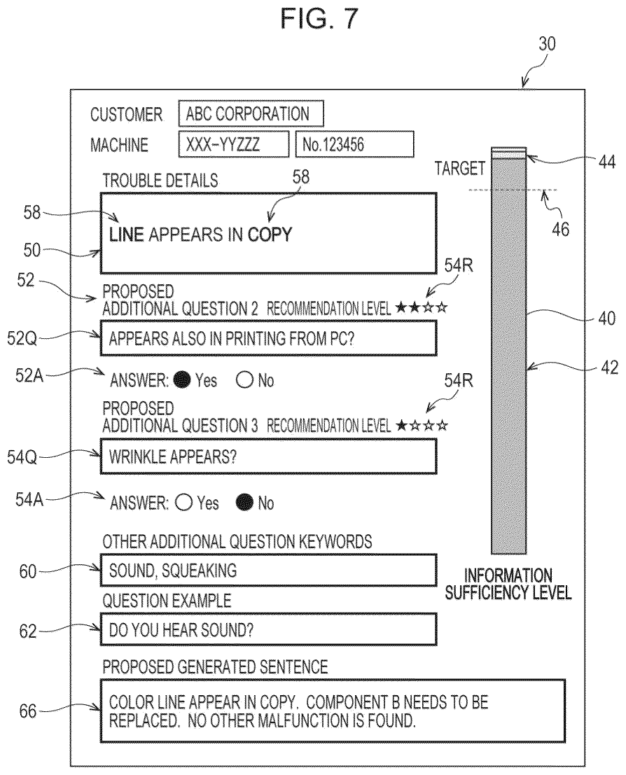

FIG. 7 illustrates an example of a state in which the responder PR has further asked the user UR a question on the content of the proposed additional question 54Q displayed in the additional question display field 52 in the state illustrated in FIG. 6, and selected the answer field 54A based on the answer obtained from the user UR. Thus, as illustrated in FIGS. 6 and 7, in the reception system 10 according to the present exemplary embodiment, even after the current value 42 of the information sufficiency level achieved by the answer from the user UR has exceeded the target value 46, the responder PR can further ask the user UR a question. FIG. 7 also illustrates that the cause of the failure has been further narrowed down based on the information provided from the user UR.

In FIGS. 5 to 7, the responder PR obtains information from the user UR by asking the user UR a question about the proposed additional question 54Q and selecting the answer field 54A corresponding to the obtained answer. The responder PR is not limited thereto, and may input the information obtained from the user UR by adding an answer from the user UR to the failure detail input field 50.

For example, the responder PR may come up with an additional question to the user UR from the words displayed in the other additional question keywords display field 60 or the example sentence displayed in the additional question example sentence display field 62, and ask the user UR the question. In this case, the responder PR inputs the content of the additional answer obtained from the user UR to the answer field 54A, and cause the calculation of the information sufficiency level.

Next, a procedure of providing the information sufficiency level to the responder PR, which is executed by the CPU 24A of the reception system 10 according to the present exemplary embodiment, will be described.

### (Procedure for Providing Information Sufficiency Level to Responder PR)

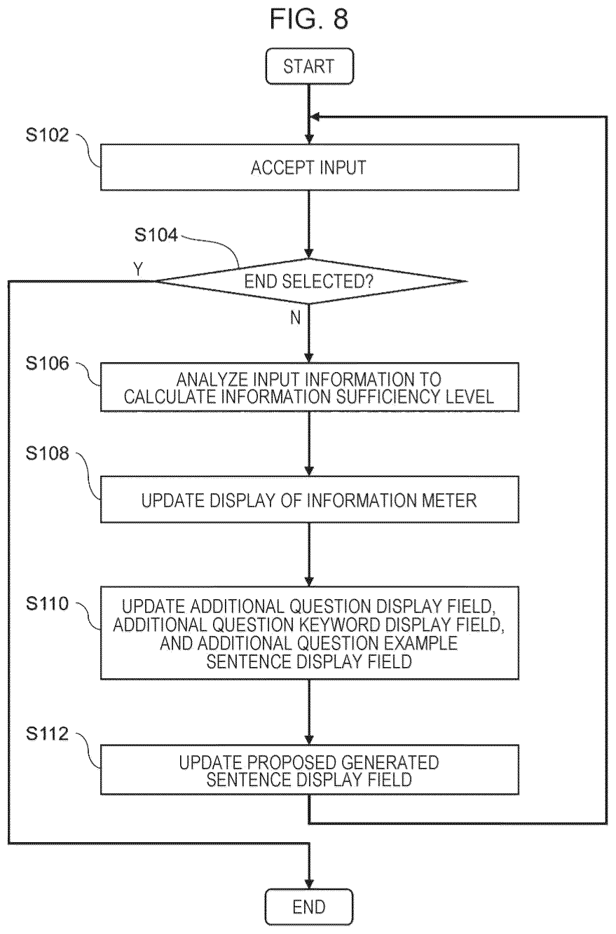

The program 25 of the reception system 10 executed by the CPU 24A includes the procedure illustrated in FIG. 8. Although not elaborated in FIG. 8, the CPU 24A assumes, as the initial value, the information sufficiency level to be “0” at the time when the procedure of receiving the content of the failure from the user UR is started.

First, in step S102, the CPU 24A receives an input from the responder PR. More specifically, in step S102, the CPU 24A waits until the responder PR makes an input to the failure detail input field 50 or the answer field 54A or makes an input (not illustrated) to end the reception system 10. Next, when any of the input to the failure detail input field 50 or the answer field 54A, or the input (not illustrated) to end the reception system 10 is made, the CPU 24A proceeds to step S104.

Next, in step S104, the CPU 24A determines whether it is selected to end the reception system 10. Upon determining NO in step S104, in other words, when new information is provided from the user UR, the CPU 24A proceeds to step S106. On the other hand, upon determining YES in step S104, in other words, when the user UR selects to end the reception system 10, the CPU 24A ends the reception system 10.

Next, in step S106, the CPU 24A analyzes the information input by the responder PR and calculates the information sufficiency level. More specifically, the CPU 24A calculates the information sufficiency level based on the words added to the failure detail input field 50 or the input made to the answer field 54A, by the responder PR. Note that a specific method of calculating the information sufficiency level by the CPU 24A will be described later. Then, the CPU 24A proceeds to step S108.

Next, in step S108, the CPU 24A updates the display of the information meter 40 based on the information sufficiency level calculated in step S106. More specifically, in step S108, the CPU 24A updates the display of the current value 42 of the information meter 40 so as to correspond to the information sufficiency level calculated in step S106. Furthermore, in step S108, the CPU 24A displays the expected increase amount 44 corresponding to the information sufficiency level expected to be achieved by the proposed additional question 54Q displayed in step S110 described later. Then, the CPU 24A proceeds to step S110.

Next, in step S110, the CPU 24A updates the display of the additional question display field 52, the additional question keywords display field 60, and the additional question example sentence display field 62, based on the information sufficiency level calculated in step S106. More specifically, in step S110, the CPU 24A updates the display of the additional question display field 52, the additional question keywords display field 60, and the additional question example sentence display field 62 so as to further increase the information sufficiency level calculated in step S106. Then, the CPU 24A proceeds to step S112.

In step S112, the CPU 24A updates the display of the proposed generated sentence display field 66 based on the information sufficiency level calculated in step S106. More specifically, in step S112, the CPU 24A generates a draft of the sentence provided to the repair person RR based on the details of the failure provided from the user UR until step S106, and updates the display of the proposed generated sentence display field 66. Then, the CPU 24A proceeds to step S102.

### (Method of Calculating Information Sufficiency Level)

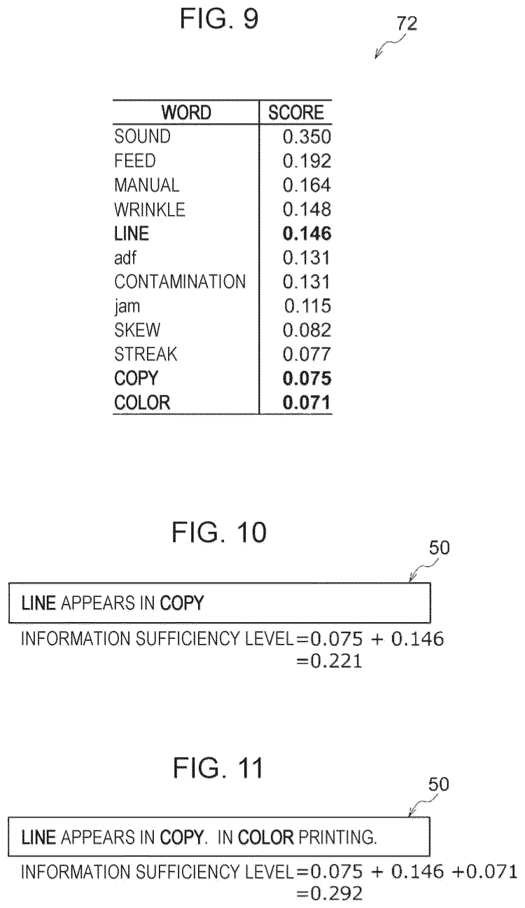

Next, an example of a method of calculating an information sufficiency level according to the present exemplary embodiment will be described with reference to FIGS. 9 to 17.

### (First Example of Method of Calculating Information Sufficiency Level)

FIG. 9 is a diagram illustrating a first example of the method of calculating the information sufficiency level and is a diagram illustrating a term-information sufficiency level correspondence table 72. FIG. 10 is a diagram illustrating the first example of the method of calculating the information sufficiency level, and is a diagram illustrating how the information sufficiency level is calculated based on terms input to the failure detail input field 50.

In this example, the CPU 24A calculates the current value 42 of the information sufficiency level based on the words input to the failure detail input field 50 and the term-information sufficiency level correspondence table 72 stored in the ROM 24C. More specifically, when the words input to the failure detail input field 50 includes words included in the term-information sufficiency level correspondence table 72, the CPU 24A increases the information sufficiency level by a score corresponding to the term.

For example, in the example illustrated in FIG. 10, the terms “copy” and “line” are each included in the term-information sufficiency level correspondence table 72. Therefore, in the example in FIG. 10, as indicated by the term-information sufficiency level correspondence table 72 in FIG. 9, the current value 42 of the information sufficiency level is 0.075+0.146=0.221.

Furthermore, for example, a case as illustrated in FIG. 11 will be considered where a further answer is obtained from the user UR and “in color printing” is input to the failure detail input field 50. Regarding such a case, the term “color” is in the term-information sufficiency level correspondence table 72. Therefore, in the example in FIG. 11, as indicated by the term-information sufficiency level correspondence table 72 in FIG. 9, the current value 42 of the information sufficiency level is 0.075+0.146+0.071=0.292.

In this example, the current value 42 of the sufficiency level of the information is thus calculated based on the words input to the failure detail input field 50 and the term-information sufficiency level correspondence table 72. In the calculation method of the present example, the current value 42 of the information sufficiency level may be calculated based on the term-information sufficiency level correspondence table 72 not only for the words input to the failure detail input field 50 described above but also for the words included in the proposed additional question 54Q.

### (Second Example of Method of Calculating Information Sufficiency Level)

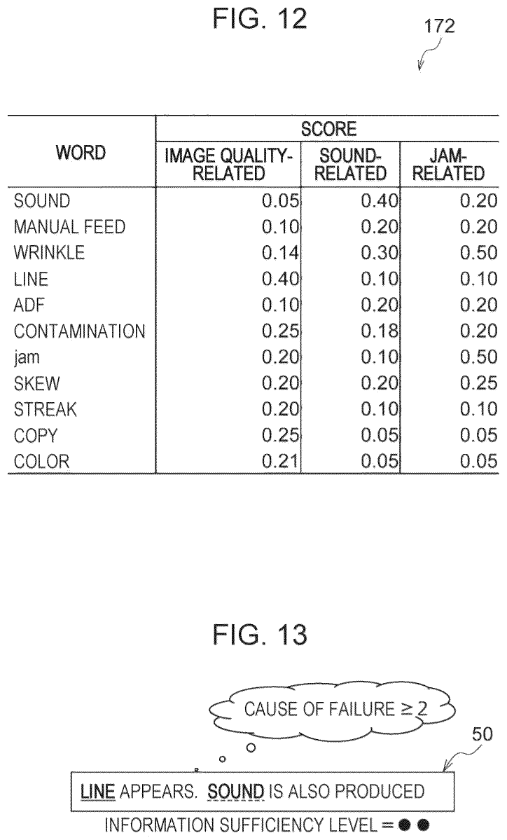

FIG. 12 is a diagram illustrating a second example of the method of calculating an information sufficiency level and is a diagram illustrating a term-information sufficiency level correspondence table 172. FIG. 12 is a diagram illustrating the second example of the method of calculating an information sufficiency level, and is a diagram illustrating how the information sufficiency level is calculated based on terms input to the failure detail input field 50.

In this example, the CPU 24A calculates the current value 42 of the information sufficiency level based on the words input to the failure detail input field 50 and the term-information sufficiency level correspondence table 172 stored in the ROM 24C. Note that in the present example, upon estimating that there are a plurality of failures, the CPU 24A calculates the information sufficiency level for each of the failures.

Regarding the words input to the failure detail input field 50, such as “line” and “sound” in the example illustrated in FIG. 13, the CPU 24A may determine that the terms are related to causes of different failures. In other words, the CPU 24A may determine that a plurality of failures can be estimated from the words input to the failure detail input field 50. For example, in the example illustrated in FIG. 13, the CPU 24A determines with the term related to “line” that there is a cause of the failure related to “image quality” in FIG. 12 and determines with the term related to “sound” that there is a cause of the failure related to “sound” in FIG. 12.

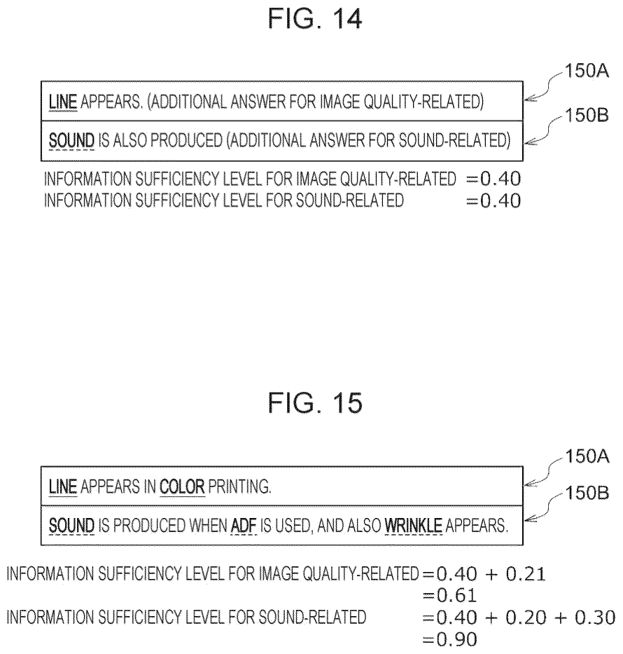

In such a case, the CPU 24A divides the failure detail input field 50 into a first failure detail input field 150A and a second failure detail input field 150B, as illustrated in FIG. 14. More specifically, the first failure detail input field 150A is an input field prompting the input of the cause of the failure related to “image quality” in FIG. 12, and the second failure detail input field 150B is an input field prompting the input of the cause of the failure related to “sound” in FIG. 12. Then, as illustrated in FIGS. 12 and 14, regarding the information sufficiency level for the failure related to “image quality”, the value of the term “line” which is 0.40 is set for the current value 42 of the information sufficiency level. As illustrated in FIGS. 12 and 14, regarding the information sufficiency level for the failure related to “sound”, the value of the term “sound” which is 0.40 is set for the current value 42 of the information sufficiency level.

Furthermore, based on the content described in the first failure detail input field 150A, the CPU 24A preferentially displays, on the additional question display field 52, the other additional question keywords display field 60, and the additional question example sentence display field 62 displayed, the content identifying the “image quality type” failure. In addition, the CPU 24A prompts the responder PR to input the answer provided from the user UR to the first failure detail input field 150A for the question for identifying the failure related to the “image quality” as illustrated in FIG. 15. Then, as illustrated in FIG. 15, since the value corresponding to the term “color” is added to the information sufficiency level corresponding to the failure related to the “image quality”, the current value of the information sufficiency level becomes 0.40+0.21=0.61.

Similarly, regarding the failure related to “sound”, the CPU 24A prompts the input, as illustrated in FIG. 15, of the answer provided by the user UR to the question for identifying the failure related to “sound” to the second failure detail input field 150B. Then, as illustrated in FIG. 15, the values corresponding to the terms “ADF” and “wrinkle” are added to the information sufficiency level related to the failure related to “sound”, the current value of the information sufficiency level becomes 0.40+0.20+0.30=0.90.

Note that also in the present example, as illustrated in FIG. 14 and FIG. 15, terms largely increasing the information sufficiency level are preferably displayed while being emphasized in the first failure detail input field 150A or the second failure detail input field 150B. Furthermore, regarding such emphasis of terms, as illustrated in FIG. 14 and FIG. 15, the terms are emphasized differently between the first failure detail input field 150A and the second failure detail input field 150B. Examples of different manners of emphasis includes varying the type of an underline to be drawn under a term, varying a character color, and the like.

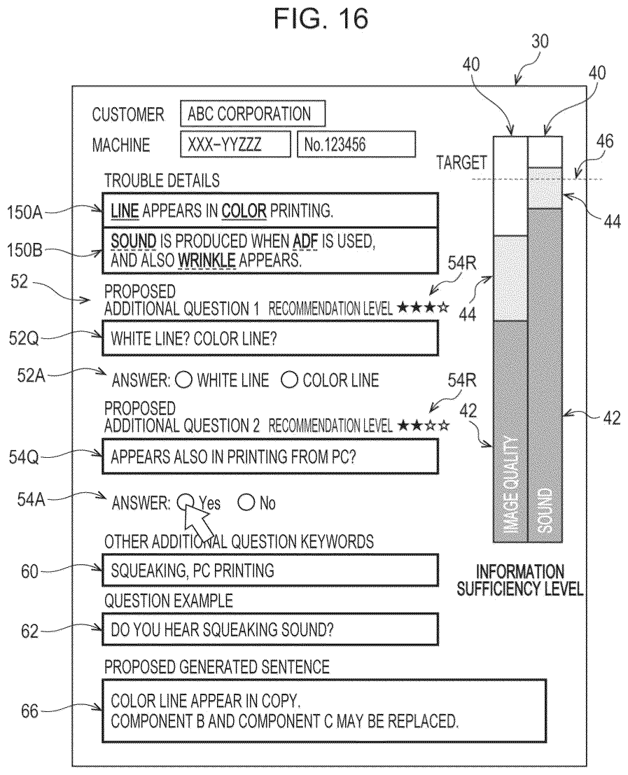

In addition, as described in the present example, in a case where the respective information sufficiency levels are calculated for the causes of the failures, the information meter 40 is preferably displayed while being divided into a plurality of parts. In the above-described example, to make the responder PR recognize the information sufficiency level for each of the causes, as illustrated in FIG. 16, the information meter 40 is preferably divided into two parts, that is, one for displaying the information sufficiency level for the “image quality” related failure and one for displaying the information sufficiency level for the “sound” related failure.

Note that while the example in which the answer obtained from the user UR is input to the first failure detail input field 150A or the second failure detail input field 150B is described with reference to FIGS. 13 to 16, the same applies to the questions displayed in the additional question display field 52. Specifically, the questions displayed in the additional question display field 52 may also be displayed separately for the causes of the failure.

The method by which the CPU 24A determines that, based on terms included in the words input to the failure detail input field 50, there are a plurality of causes of failures as described above is not particularly limited. For example, a method may be employed in which it is determined that there are a plurality of causes of failure when the CPU 24A determines that the time at which the malfunction estimated from the words input to the failure detail input field 50 is different from the time described by the input words. In addition, for example, a method may be employed in which the CPU 24A determines that there are a plurality of failure causes with respect to the pattern for which the words are input, with reference to a trained model generated based on a past record or the like.

Furthermore, while the CPU 24A divides the failure detail input field 50 into the first failure detail input field 150A and the second failure detail input field 150B as illustrated in FIG. 14, the CPU 24A may ask the responder PR, before dividing the input field, whether the input fields need to be divided.

### (Third Example of Method of Calculating Information Sufficiency Level)

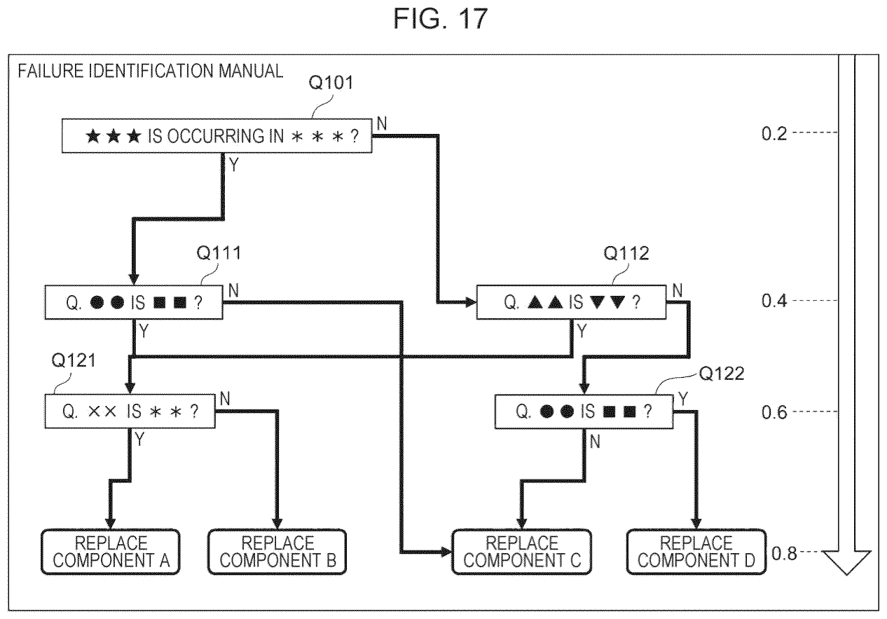

FIG. 17 is a diagram illustrating a third example of the method of calculating the information sufficiency level, and is a diagram illustrating a manual for addressing the cause of the failure, which is provided to a repair person RR who repairs the printer 12.

As illustrated in FIG. 17, the manual defines a plurality of questions to be asked, as well as the content of the next question corresponding to the obtained answer. Furthermore, as illustrated in FIG. 17, with the manual, an operation to be finally performed by the repair person RR (an operation of replacing a component in FIG. 17) is derived through questions repeatedly asked.

The method of calculating the current value 42 of the information sufficiency level in this example is determined in accordance with the number of questions remaining in the manual until the work is finally derived. In the example of FIG. 17, the information sufficiency level becomes 0.2 when the answer to step Q101 is obtained, and the information sufficiency level becomes 0.4 when the answer to step Q111 or step Q112 is obtained. Similarly, in the example of FIG. 17, the information sufficiency level becomes 0.6 when the answer to step Q121 or step Q122 is obtained, and the information sufficiency level becomes 0.8 when the work to be performed by the repair person RR is finally derived.

As described above, in the third example of the calculation method, the information sufficiency level is calculated based on the manual. Therefore, according to this example, also in an existing device such as the printer 12, the information sufficiency level can be calculated based on the manual of the device.

Furthermore, the first to third examples described above may be combined. For example, as in the third example, the work to be performed by the repair person RR may be narrowed down based on the manual, and furthermore the current value 42 of the information sufficiency level may be calculated based on the term-information sufficiency level correspondence table 72, using the term included in the answer obtained from the user UR. Thus, the responder PR can increase the information sufficiency level from that with the steps described in the third example.

Note that the numerical values in the above-described first to third examples are provided for convenience, and actual values are not limited thereto. Thus, the maximum value of the information sufficiency level may be set in any manner, or the maximum value may not be set. Similarly, the target value 46 of the information sufficiency level may be set in any manner.

Note that in the reception system according to the present exemplary embodiment, the responder PR may end the interaction with the user UR at any time point.

For example, as illustrated in FIG. 3, the responder PR may end at his or her will, the interaction with the user UR even in a state where the current value 42 of the sufficiency level of information obtained from the user UR is insufficient. Specifically, the responder PR ends the interaction with the user UR, in situations such as a case where it is determined that the content of the question obtained from the responder PR is not addressed to the call center where the responder PR works, or when the user UR refuses to interact with the responder PR.

Similarly, in the situations illustrated in FIGS. 4 to 6, the responder PR may end at his or her will, the interaction with the user UR even while the accumulation of information through the interaction with the user UR is still in progress. In other words, the responder PR using the reception system 10 according to the present exemplary embodiment is given authority to determine whether to continue the interaction with the user UR while checking the information meter 40 or the like displayed on the display unit 30.

With the reception system 10 and the program 25 according to the present exemplary embodiment, the following operations and effects are achieved.

### Operations and Effects

The reception system 10 according to the present exemplary embodiment displays, using the information meter 40, the current value 42 of the sufficiency level of the information leading to the solution for the failure, which is included in the information provided from the user UR using the device in which the failure has occurred. Therefore, the reception system 10 according to this mode makes it easier for the responder PR, who responds to the user UR using the device in which the failure has occurred, to determine the suitability of the response, as compared with a case where only a question to the user UR and an answer are displayed to the responder PR.

The reception system 10 according to the present exemplary embodiment displays, to the responder PR, candidates for the next question to the user UR leading to the solution for the failure. Therefore, the reception system 10 according to the present exemplary embodiment enables the responder PR, responding to the user UR, to know a suitable question to be asked to the user UR.

In addition, the reception system 10 according to the present exemplary embodiment further displays, to the responder PR, the information sufficiency level added when information is provided from the user UR for the question, as the expected increase amount 44. Therefore, with the reception system 10 according to the present exemplary embodiment, the responder PR can review the suitability of the next question.

Furthermore, the reception system 10 according to the present exemplary embodiment displays, to the responder PR, a plurality of words in the additional question display field 52 and the additional question keywords display field 60. Therefore, with the reception system 10 according to the present exemplary embodiment, the responder PR can select the next question to be asked.

Furthermore, the reception system 10 according to the present exemplary embodiment displays the additional question display field 52 in descending order of the amount of increase in the information sufficiency level. Therefore, the reception system 10 according to the present exemplary embodiment makes it easier for the responder PR to determine the question to be preferentially asked, as compared with a case where the candidates for the additional question display field 52 are randomly provided to the responder PR.

In addition, the reception system 10 according to the present exemplary embodiment displays content to be reported to the next person in charge by the responder PR, in the proposed generated sentence display field 66 based on the information provided from the user UR. Therefore, with the reception system 10 according to the present exemplary embodiment, even a responder PR who is not so experienced in the response for the failure can provide the content to be reported to the next person in charge.

The reception system 10 according to the present exemplary embodiment displays, to the responder PR, the content related to the solution for the failure to be displayed to the next person in charge by the responder PR, together with the candidate for the question to the user UR. Therefore, with the reception system 10 according to the present exemplary embodiment, the responder PR can select the question to the user UR after confirming the content to be displayed to the next person in charge.

The reception system 10 according to the present exemplary embodiment changes the content related to the solution for the failure in accordance with the current value 42 of the information sufficiency level, and displays the changed content to the responder PR in the proposed generated sentence display field 66. Therefore, with the reception system 10 according to the present exemplary embodiment, the next person in charge can more easily understand the content related to the solution for the failure, as compared with a case where the content related to the solution for the failure to be provided to the responder PR remains to be the same regardless of the information sufficiency level.

In addition, the reception system 10 according to the present exemplary embodiment uses highlighted display 58 to highlight and display, to the responder PR, the information that is included in the information provided from the user UR and increases the information sufficiency level. Therefore, the reception system 10 according to the present exemplary embodiment can provide, to the responder PR, the information sufficiency level obtained based on the information provided from the user UR as a feedback.

Further, the program 25 according to the present exemplary embodiment causes the processor to execute displaying, using the information meter 40, the sufficiency level of the information leading to the solution for the failure, which is included in the information provided from the user UR using the device in which the failure has occurred. Therefore, the program 25 according to the present exemplary embodiment makes it easier for the responder PR, who responds to the user UR using the device in which the failure has occurred, to determine the suitability of the response, as compared with a case where the processor displays only a question to the user UR and an answer to the responder PR.

### Modifications

In the above description, the reception system 10 provides, to the responder PR, the information sufficiency level by displaying the information meter 40, but the reception system 10 according to the present exemplary embodiment is not limited thereto, as long as the current value 42 of the information sufficiency level can be provided to the responder PR. For example, instead of the display method using the information meter 40 that is the progress bar, the information sufficiency level may be displayed as a numerical value, or the information sufficiency level may be indicated by the size, shape, position, color, or the like of an icon or the like displayed on the display unit 30. Further, instead of the display by the display unit 30, the information sufficiency level may be provided to the responder PR as auditory information such as a sound emitted.

In the above description, the CPU 24A displays the proposed additional question 54Q, the other additional question keywords, and the additional question example sentence to the responder PR together with the information meter 40, but the operation of the reception system 10 according to the present exemplary embodiment is not limited thereto. Specifically, a mode may be employed in which for the responder PR to determine the suitability of the response to the user UR, the CPU 24A does not display the proposed additional question 54Q, the other additional question keywords, and the additional question example sentence, and displays only the information meter 40 to the responder PR responding to the user UR.

In the above description, the CPU 24A displays the expected increase amount 44 on the information meter 40. However, the operation of the reception system 10 according to the present exemplary embodiment is not limited thereto. For example, a mode may be adopted in which CPU 24A does not display the expected increase amount 44, and the responder PR determines how to respond to the user UR while checking the current value 42 of the information sufficiency level displayed based on the information obtained from the user UR.

In the above description, the CPU 24A displays a plurality of the proposed additional questions 54Q to the responder PR, but the operation of the reception system 10 according to the present exemplary embodiment is not limited thereto. For example, the CPU 24A may display only one proposed additional question 54Q on the display unit 30.

Furthermore, in the above description, the CPU 24A displays the proposed additional questions 54Q in the descending order of the expected increase amount 44, but the operation of the reception system 10 according to the present exemplary embodiment is not limited thereto. For example, the CPU 24A may display the proposed additional questions 54Q on the display unit 30 randomly, or in the ascending order of the expected increase amount 44.

Furthermore, while the CPU 24A generates a sentence to be provided to the repair person RR and displays it in the proposed generated sentence display field 66 of the display unit 30 in the description above, the operation of the reception system 10 according to the present exemplary embodiment is not limited thereto. For example, a mode may be adopted in which the CPU 24A does not display a sentence in the proposed generated sentence display field 66, and displays to the responder PR, the sentence provided to the repair person RR, after the responder PR ends interaction with the user UR. Further, a mode may be adopted in which, the CPU 24A does not display a sentence on the proposed generated sentence display field 66, and provides, to the repair person RR, the content described in the failure detail input field 50, the answer to the additional question display field 52, and the like that are the answer obtained from the user UR, after the responder PR ends interaction with the user UR.

Further, in the above description, the CPU 24A highlights and presents to the responder PR, the information that is included in the information provided from the user UR and increases the information sufficiency level using the highlighted display 58, but the operation of the reception system 10 according to the present exemplary embodiment is not limited thereto. That is, a mode may be employed in which the CPU 24A does not provide the highlighted display 58 and displays only the information meter 40 to the responder PR responding to the user UR, for the responder PR to determine the suitability of the response to the user UR.

Even with these modifications, it is possible to obtain the same operations and effects as those described above.

While the exemplary embodiments of the present disclosure have been described with reference to the accompanying drawings, it is apparent that those skilled in the art to which the present disclosure pertains can conceive various modifications and applications within the scope of the technical idea described in the claims, and it is to be understood that these naturally belong to the technical scope of the present disclosure.

### APPENDIX

(((1)))

An information processing system comprising a processor configured to provide, to a responder who responds to a user using a device in which a failure has occurred, a sufficiency level of information regarding a solution for the failure based on information provided from the user.

(((2)))

The information processing system according to (((1))), wherein the processor is configured to provide, to the responder, a candidate for a question to the user, the question contributing to an increase in the sufficiency level of the information.

(((3)))

The information processing system according to (((1)) or ((2)), wherein the failure is one of a plurality of failures, and when the plurality of failures are estimated, the processor is configured to provide the sufficiency level of the information for each of the failures.

(((4)))

The information processing system according to (((2))) or (3))), wherein the processor is further configured to provide, to the responder, an amount of increase in the sufficiency level of the information, in response to provision of information from the user for the candidate for the question.

(((5)))

The information processing system according to any one of (((2))) to (((4))), wherein the processor is configured to provide, to the responder, a plurality of candidates for the question.

(((6)))

The information processing system according to (((5))), wherein the processor is configured to provide the plurality of candidates for the question in descending order of an amount of increase in the sufficiency level of the information.

(((7)))

The information processing system according to any one of (((1) to 5))), wherein the processor is configured to generate content related to a solution for the failure of the device, to be provided to a next person in charge by the responder, based on the information provided from the user.

(((8)))

The information processing system according to (((7))) citing any one of (((2))) to (((5))), wherein the processor is configured to provide, to the responder, the content related to the solution for the failure together with the candidate for the question.

(((9)))

The information processing system according to (((7))) or (((8))), wherein the processor is configured to change the content related to the solution for the failure in accordance with the sufficiency level of the information.

(((10)))

The information processing system according to any one of (((1) to (9))), wherein the processor is configured to highlight and present to the responder, information that is included in the information provided from the user and largely increases the sufficiency level of the information.

(((11)))

A program causing a process comprising providing, to a responder who responds to a user using a device in which a failure has occurred, a sufficiency level of information regarding a solution for the failure based on information provided from the user

What is claimed is:

1. An information processing system comprising:
a processor configured to provide, to a responder who responds to a user using a device in which a failure has occurred, a sufficiency level of information regarding a solution for the failure based on information provided from the user.

2. The information processing system according to claim 1, wherein the processor is configured to provide, to the responder, a candidate for a question to the user, the question contributing to an increase in the sufficiency level of the information.

3. The information processing system according to claim 1, wherein the failure is one of a plurality of failures, and when the plurality of failures are estimated, the processor is configured to provide the sufficiency level of the information for each of the failures.

4. The information processing system according to claim 2, wherein the processor is further configured to provide, to the responder, an amount of increase in the sufficiency level of the information, in response to provision of information from the user for the candidate for the question.

5. The information processing system according to claim 2, wherein the processor is configured to provide, to the responder, a plurality of candidates for the question.

6. The information processing system according to claim 5, wherein the processor is configured to provide the plurality of candidates for the question in descending order of an amount of increase in the sufficiency level of the information.

7. The information processing system according to claim 2, wherein the processor is configured to generate content related to a solution for the failure of the device, to be provided to a next person in charge by the responder, based on the information provided from the user.

8. The information processing system according to claim 7, wherein the processor is configured to provide, to the responder, the content related to the solution for the failure together with the candidate for the question.

9. The information processing system according to claim 7, wherein the processor is configured to change the content related to the solution for the failure in accordance with the sufficiency level of the information.

10. The information processing system according to claim 1, wherein the processor is configured to highlight and present to the responder, information that is included in the information provided from the user and largely increases the sufficiency level of the information.

11. The information processing system according to claim 2, wherein the processor is configured to highlight and present to the responder, information that is included in the information provided from the user and largely increases the sufficiency level of the information.

12. The information processing system according to claim 3, wherein the processor is configured to highlight and present to the responder, information that is included in the information provided from the user and largely increases the sufficiency level of the information.

13. The information processing system according to claim 4, wherein the processor is configured to highlight and present to the responder, information that is included in the information provided from the user and largely increases the sufficiency level of the information.

14. The information processing system according to claim 5, wherein the processor is configured to highlight and present to the responder, information that is included in the information provided from the user and largely increases the sufficiency level of the information.

15. The information processing system according to claim 6, wherein the processor is configured to highlight and present to the responder, information that is included in the information provided from the user and largely increases the sufficiency level of the information.

16. The information processing system according to claim 7, wherein the processor is configured to highlight and present to the responder, information that is included in the information provided from the user and largely increases the sufficiency level of the information.

17. The information processing system according to claim 8, wherein the processor is configured to highlight and present to the responder, information that is included in the information provided from the user and largely increases the sufficiency level of the information.

18. The information processing system according to claim 9, wherein the processor is configured to highlight and present to the responder, information that is included in the information provided from the user and largely increases the sufficiency level of the information.

19. A non-transitory computer readable medium storing a program causing a process comprising:
providing, to a responder who responds to a user using a device in which a failure has occurred, a sufficiency level of information regarding a solution for the failure based on information provided from the user
